(19) United States
(12) Patent Application Publication
(10) Pub. No.: US 2006/0215638 A1
(43) Pub. Date: Sep. 28, 2006

(54) Private branch exchange, private branch exchange system, and terminal unit registration method

(75) Inventor: Koji Abe, Fukuoka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/384,436

(22) Filed: Mar. 21, 2006

(30) Foreign Application Priority Data
Mar. 23, 2005 (JP) 2005-083100
Mar. 24, 2005 (JP) 2005-085507
Feb. 8, 2006 (JP) 2006-030811

(51) Int. Cl. H04L 12/66

(52) U.S. Cl. 370/352

(57) ABSTRACT

A communication address request notification which inquires about an IP address of a private branch exchange 2 is transmitted from an IP telephone 3a to be newly accommodated. A private branch exchange 2 or an IP telephone 3b which has received the communication address request notification transmits the IP address of the private branch exchange 2 as a communication address response notification, if the IP address of the private branch exchange 2 to be the registration destination is stored in a memory of the private branch exchange 2 or a memory of the IP telephone 3b. Then, the IP telephone 3a which has received the communication address response notification stores this IP address as the IP address of the private branch exchange 2 of the registration destination in the memory.

### BACKGROUND OF THE INVENTION

The present invention relates to a private branch exchange system and a terminal registration method for newly connecting a terminal to a private branch exchange over a LAN (Local Area Network, hereinafter referred to as network) constructed by Ethernet (Registered Trademark).

As extension telephones used in offices, etc., IP (Internet Protocol) telephones using networks have been widely used. PC (Personal Computer) telephones in which a personal computer is equipped with a telephone function, and customer's information is received from a private branch exchange so as to be displayed on a screen when there is an incoming call are connected by private branch exchanges and networks and have been in a call center, etc. Moreover, there are voice storage devices in which, when a user who uses an IP telephone is absent, messages to the user are stored, and the messages are later transmitted to user as a mail voice. The voice storage devices are also stored to a private branch exchange over networks.

Terminal apparatuses such as the IP telephones, the PC telephones, the voice storage devices, and the like are hereinafter generically called as terminal units. The terminal units equipped with these various functions are connected to a private branch exchange and communicated with one another, and thus the units are allowed to exhibit their respective functions, thereby promoting users' convenience. The following description will be made of an embodiment in which an IP telephone is used as an example of the terminal units, and a private branch exchange is used as an example of a private branch exchange which accommodates the IP telephone. A communication network constitutes a LAN (hereinafter referred to as network) which performs communication by using various kinds of protocols on the Ethernet (Registered Trademark).

The private branch exchange is provided with an information table that is used to determine allows whether a terminal unit (a unit which can be connected to the private branch exchange) as an incoming destination when there is an incoming call from an outside line or an extension line is an accommodated terminal unit or not. In this table, identity information that can identify terminal units, communication addresses, extension numbers, incoming call groups, and the like are correlated with one another and stored as the exchange communicating information. Accordingly, when a terminal unit to be accommodated is installed, it is necessary to set various kinds of information of the terminal unit to be newly installed, in the information table of the private branch exchange. Meanwhile, even in the terminal unit to be newly installed, it is necessary to set the communication address of a private branch exchange to be a registration destination. The setting of the terminal unit includes the communication address of the terminal unit that is a communication source, the communication address of a private branch exchange to be a communication destination which accommodates the terminal unit, and the like.

The communication address is called an IP address when a network is TCP/IP (Transmission Control Protocol/Internet Protocol). In a case of IPv4 (Internet Protocol Version 4) which is presently widely used, numerical values of 32 bits divided into four by eight bits are used.

The IP address to be a communication source can be allocated simply by being connected to a network by disposing a DHCP (Dynamic Host Configuration Protocol) server on the network, or by allowing a private branch exchange, which accommodates a terminal unit to be newly installed, to have functions of the DHCP server. As for the technique of adding a terminal to the network or eliminating a terminal from the network, there is a technique described in JP-A-10-303915 as in an ATM network.

However, in the above related art, when various terminal units are newly installed or additionally installed, it was necessary to manually perform updating of an information table of a system including a private branch exchanges and setting of the communication address of a private branch exchange as a registration destination which accommodates the terminal units. Although the updating of the information table may be performed only for one private branch exchange, the setting of the communication address of the private branch exchange becomes more complicated as the number of private branch exchanges to be installed increases. Thus, there is a problem in that erroneous setting may be performed as well as much time is required.

### SUMMARY OF THE INVENTION

It is therefore the object of the present invention to provide a terminal unit, a private branch exchange, a private branch exchange system, a communication address notification method of the terminal unit and a communication address notification method of the private branch exchange, which make it possible to easily and exactly perform communicating setting of the private branch exchange.

A terminal unit newly connected to a network transmits a communication address request notification which inquires about the communication address of a private branch exchange. If an already connected and accommodated terminal unit which has received the communication address request notification stores the communication address of a private branch exchange to be a registration destination, it transmits the communication address of the private branch exchange to be a registration destination, as a communication address response notification.

A terminal unit newly connected to a network can acquire the communication address of a private branch exchange to be a registration destination from the network, and start a communication operation with the private branch exchange. Accordingly, an operator does not have to manually perform setting of the private branch exchange, and thus erroneous setting of the private branch exchange can be prevented, whereby the communicating setting of the private branch exchange can be performed easily and exactly.

### BRIEF DESCRIPTION OF THE DRAWINGS

FIG. 1 is a block diagram showing the configuration of a private branch exchange system according to Embodiment 1 of the present invention.

FIG. 2 is a block diagram showing the configuration of a private branch exchange of FIG. 1.

FIGS. 3A to 3D illustrate the exchange communicating information stored in the memory of FIG. 2.

FIG. 4 is a block diagram showing the configuration of each IP telephone of FIG. 1.

FIG. 5 is a table showing an example of information stored by the memory of FIG. 4.

FIG. 6 is a sequence chart for explaining the operation of the private branch exchange system according to Embodiment 1.

FIG. 7 is a flowchart for explaining the operation of an IP telephone to be newly installed in FIG. 6.

FIG. 8 is a flowchart for explaining the operation of a private branch exchange in FIG. 6.

FIG. 9 is a flowchart for explaining the operation of an existing IP telephone in FIG. 6.

FIG. 10 is a sequence chart for explaining the operation of the private branch exchange system according to Embodiment 2 of the present invention.

FIG. 11 is a flowchart for explaining the operation of an IP telephone to be newly installed in FIG. 10.

FIG. 12 is a flowchart for explaining the operation of a private branch exchange in FIG. 10.

FIG. 13 is a flowchart for explaining the operation of an existing IP telephone in FIG. 10.

FIG. 14 is a block diagram showing the configuration of a private branch exchange system according to Embodiment 3 of the present invention.

FIG. 15 is a sequence chart for explaining the operation of the private branch exchange system of FIG. 14.

FIG. 16 is a flowchart for explaining the operation of a newly installed IP telephone in FIG. 14.

FIG. 17 is a flowchart for explaining the operation of an existing IP telephone in FIG. 14.

FIG. 18 is a block diagram showing the configuration of a private branch exchange system according to Embodiment 4 of the present invention.

FIG. 19 is a sequence chart for explaining the operation of the private branch exchange system of FIG. 18.

FIG. 20 is a flow chart for explaining the operation of a private branch exchange in FIG. 18.

### DESCRIPTION OF THE PREFERRED EMBODIMENTS

### Embodiment 1

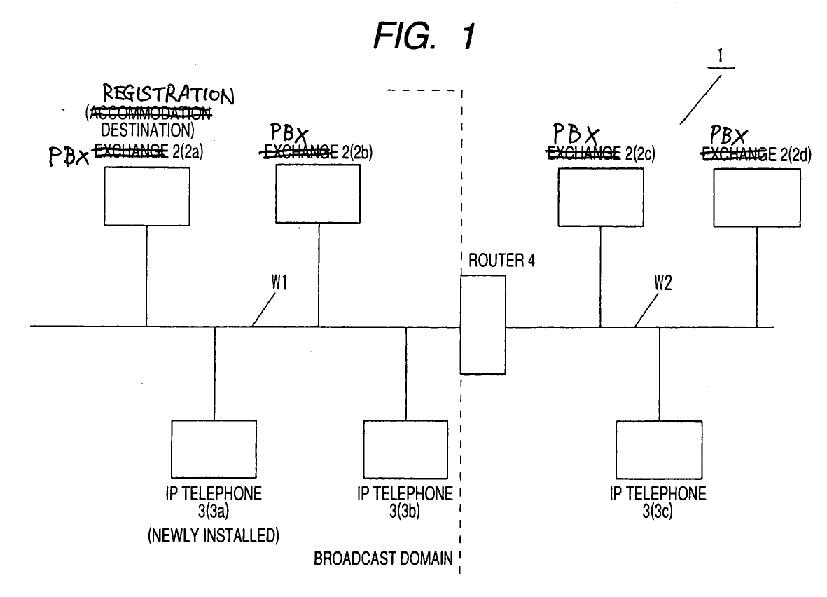

The configuration of a private branch exchange system, using terminal units (hereinafter, referred as terminal equipments) and private branch exchanges, according to Embodiment 1 of the present invention will be described with reference to FIG. 1. Here, the configuration of the private branch exchange system will be described taking as an instance a case in which the terminal equipments (private branch exchange connection units) are IP telephones. FIG. 1 is a block diagram the configuration of the private branch exchange system according to Embodiment 1 of the present invention.

<Configuration of Private Branch Exchange System>

Referring to FIG. 1, the private branch exchange system 1 includes private branch exchanges 2 (2a to 2d, and abbreviated to PBX), and IP telephones 3 (3a to 3c). The private branch exchanges 2 are configured such that a private branch exchange (registration destination) 2a and a private branch exchange 2b are connected to a network W1 in the same broadcast domain. An IP telephone 3a and an IP telephone 3b are also connected to the network W1. In addition, it is assumed that the private branch exchanges 2 in the present specification mean exchanges (for instance, call servers are also included in making the exchanges implement functions as will be described in examples) in the premises.

Private branch exchanges 2c and 2d and an IP telephone 3c are connected to a network W2 which is connected to the network W1 via a router 4. In this embodiment, although the networks W1 and W2 adopt LANs (Local Area Networks) transmitted using TCP/IP (Transmission Control Protocol/Internet Protocol), the networks may use any other communication protocols as long as they are communicable.

Although only three IP telephones 3 are shown in FIG. 1 for the sake of convenience, three or more IP telephones may be connected to the networks. The terminal equipments are not limited to the IP telephones 3 as long as they are communicable with the private branch exchanges 2. For example, telephone answering machines (TAMs), etc. may be used. In addition, illustration of network multiplexers, such as hubs, DHCP servers, and the like are omitted in FIG. 1.

<Configuration of Private Branch Exchange>

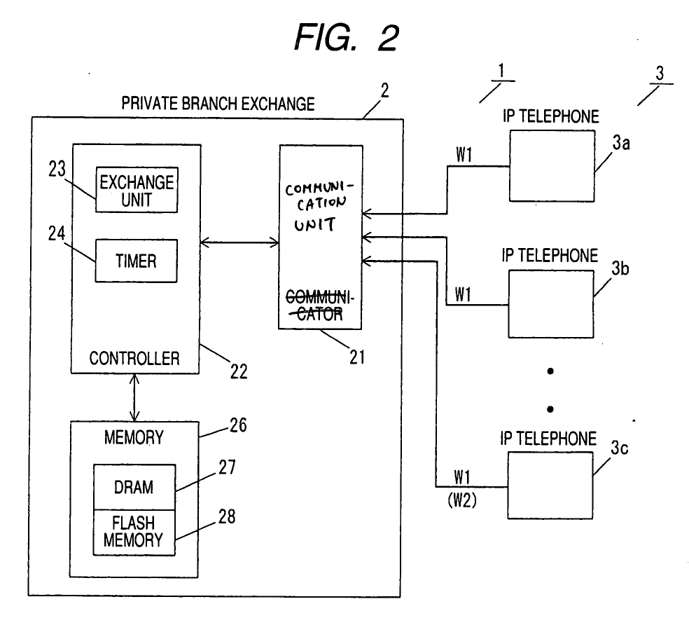

Next, the configuration of the private branch exchanges 2 will be described with reference to FIG. 2. FIG. 2 is a block diagram showing the configuration of a private branch exchange of FIG. 1. The private branch exchange 2 has a communicator 21 (hereafter, more definitely referred as communication unit) that is an interface with the networks W1 and W2, a controller 22 which controls a private branch exchange function on the information performed with the private branch exchange 2, and a memory 26 which stores data and programs.

The communication unit 21, which is an interface between the private branch exchange 2 and the networks W1 and W2, enables the private branch exchanges 2 to communicate system data with each other over the networks W1 and W2. In addition, the communication unit 21, which is an interface for connection to the LANs described at the beginning, can be implemented using publicly known and publicly used network interfaces. Therefore, details of the internal configuration thereof are omitted herein.

The communication of system data by the communication unit 21 is performed for implementing linking of the system data between the private branch exchanges 2. The communication unit 21 can also update exchange communicating information, as will be described below, in this embodiment. In addition, although the system data can also be distributed using a center system other than the system configuration as will be described in detail below, this is not the subject matter of the present invention. Thus, description thereof will be omitted herein.

The communication unit 21 controls connection and disconnection of an incoming call to a speech path switch. The communication unit 21 also has a function to transmit a voice according to a state, such as a busy tone indicative of an incoming state, a tone indicative of a calling state, or the like, with respect to a call.

Moreover, the communication unit 21 has a function to transmit a voice (progress tone) according to a state, such as a busy tone indicative of an incoming state, a tone indicative of a calling state, or the like, to an IP telephone 3 to be accommodated. A communication address request notification (a notification that requests the IP address of a private branch exchange 2 as a registration destination) and a registration request notification (a notification that requests registration setting to the private branch exchange 2, which are transmitted from the IP telephone 3), are transmitted to the controller 22 via the communication unit 21. Further, a communication address response notification (a response notification to the communication address request notification) and a registration response notification (a response notification to the registration request notification) from the controller 22 are also transmitted to the IP telephone 3 to be accommodated, via the communication unit 21. When the communication unit 21 communicates with the IP telephone 3 to be accommodated, by broadcast or unicast, it performs communication by the control from the controller 22.

The controller 22 performs a control on a communication control sequence over the networks W1 and W2 and packets relating to incoming and outgoing calls, and a control on the overall system. The controller 22 includes an exchange unit 23 as a means implementing an exchange control on information by the control of packets. The exchange unit 23 can also use (include) a time division switch function for implementing linking with conventional digital exchange.

Moreover, the controller 22 is equipped with a timer 24 that is a time measuring means. The timer 24 is provided as one of peripheral control functions integrated on one chip of a CPU (not shown) of the controller 22. For example, the timer 24 obtains time measurement results by counting CPU clock signals. Accordingly, the timer 24 functions as a programmable timer by programming a counting value. The timer 24 in Embodiment 1 has a function relating to a time control as will be described below.

The memory 26 is composed of a DRAM 27 that is a volatile memory, a flash memory 28 that is a nonvolatile memory, and a peripheral control circuit (not shown). The DRAM 27 is used to store system operating programs and various kinds of setting data for primary storage of data. For example, a DRAM-IC having a capacity of 128 Mbytes is used as the DRAM 27.

The flash memory 28 is used to store control programs and setting information. For example, a hard disc, a flash memory IC, and an SD card memory, each having a capacity more than 128 Mbytes, is used as the flash memory. In particular, since the SD card memory can be attached and detached, it is possible to cope with replacement of a card as well as partial rewriting of stored contents when system operating programs are updated.

As the setting information stored by the flash memory 28, for example, there is exchange communicating information (information tables) in which identity information that identifies the IP telephones (terminal equipments) 3 are correlated (associated) with communication addresses of private branch exchanges (PBX) as registration destinations to accommodate the IP telephones 3.

As the identity information that identifies the IP telephones 3, MAC (Media Access Control) addresses are adopted in this Embodiment 1. In addition, the identity information that identifies the IP telephones 3 may be IP addresses allocated to the IP telephones 3, system numbers allocated by the private branch exchanges 2, and extension numbers, as long as it can identify an IP telephone 3 from other IP telephones 3 within the private branch exchange system 1. The MAC addresses are desirable as the identity information of the terminal equipments because their values are not changed even if an IP telephone 3 is relocated to a different place and connected therefrom. The MAC addresses of the private branch exchanges 2 and the IP telephones 3 are written in their respective memories 26 at the time of completion and shipment of products.

Moreover, the identity information of the IP telephones 3 may be command packets of a communication address request notification that can link with the private branch exchange system 1, in addition to the above-described MAC addresses. This is because, when an IP telephone 3 is newly connected to the network WI, the very fact that the communication address request notification can be transmitted means the IP telephone 3 which can link with the private branch exchange system, which enables a connection control of the present invention to be started. Accordingly, the identity information in this embodiment is used as a broad meaning, including the MAC addresses, indicating that a communication address request notification can be transmitted.

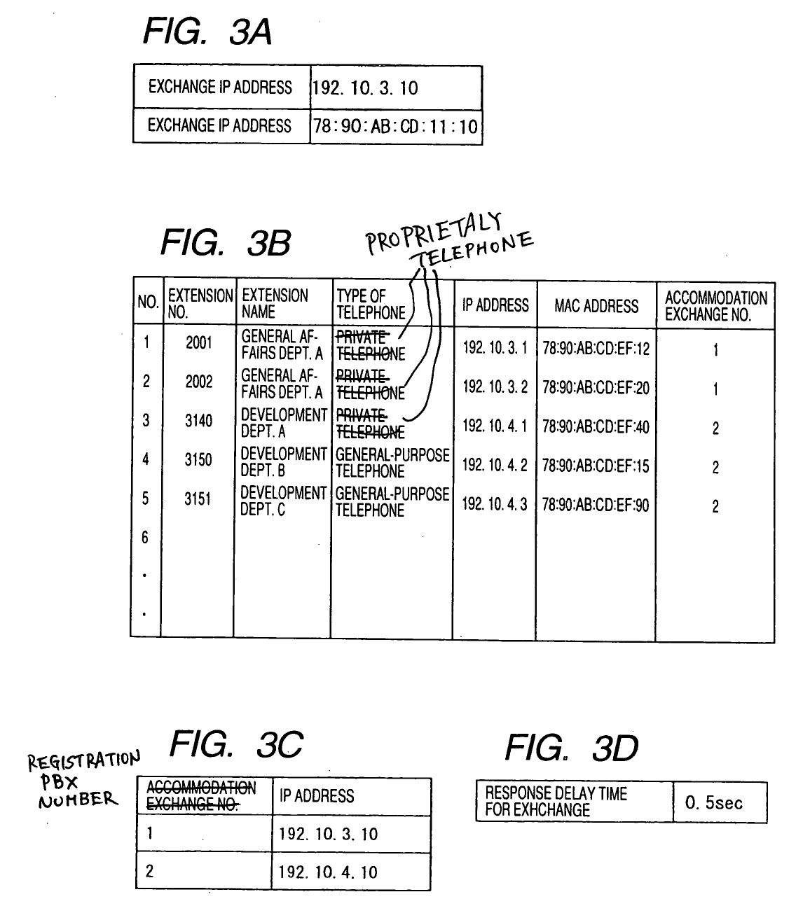

Here, the exchange communicating information stored in the memory 26 will be described in detail with reference to FIGS. 3A to 3D. FIGS. 3A to 3D show the exchange communicating information to be stored in the memory of FIG. 2. In FIGS. 3A to 3D, an example of contents in the memory 26 of the private branch exchange 2a is shown. FIG. 3A shows the self-addresses of the private branch exchange, FIG. 3B shows an information table on the exchange communicating information, FIG. 3C shows an information table in which numbers of registration destination private branch exchanges are correlated with IP addresses of the private branch exchanges, and FIG. 3D shows an information table of response delay time of the private branch exchange.

As shown in FIG. 3A, “192.10.3.10” allocated to a private branch exchange 2 is stored in the memory 26 as a self-address (private branch exchange IP address). Further, a self-MAC address (private branch exchange MAC address) “78:90:AB:CD:11:10” is stored at the time of shipment of a product (before connection of the product to the private branch exchange system 1).

As shown in FIG. 3B, as the exchange communicating information, information including extension numbers, extension names, types of telephones, IP addresses, MAC addresses, private branch exchange numbers (registration PBX numbers) of the private branch exchanges 2 as the registration destinations are correlated (associated) with one another and stored in the memory 26. In addition to these kinds of information, the exchange communicating information includes information on incoming call groups, information that defines functions of function keys possessed by the IP telephones 3, and the like (not shown). Further, the private branch exchange numbers of the private branch exchanges 2 as the registration destinations are correlated with the IP addresses of the private branch exchanges 2 shown in FIG. 3C and stored. In addition, in the following description, all the above information is often generically called “connecting information.”

The information table of the response delay time for the private branch exchange shown in FIG. 3D is information indicating the delay time to be taken from when a communication address request notification has been received from an IP telephone 3 to when a communication address response notification to the IP telephone 3 is transmitted.

Referring back to FIG. 2, the controller 22 of the private branch exchange 2 has a function to cause the contents of the exchange connecting information stored in the memory 26 to be the same as the contents of the exchange connecting information stored in the memory 26 of other private branch exchange 2. This function is a function for operating a plurality of private branch exchanges shown in FIG. 1 systematically, that is, the above-mentioned system data linking function. For example, when the exchange connecting information of the private branch exchange 2a is updated in order to newly install an IP telephone 3 in the private branch exchange system 1, the private branch exchange 2a communicates with the private branch exchange 2b and the private branch exchange 2c via the communication unit 21 and the networks W1 and W2 to update the exchange connecting information of the private branch exchange 2b and private branch exchange 2c. Further, when a communication address request notification that requests, the IP address of a private branch exchange 2 as a registration destination from the newly installed IP telephone 3 is transmitted, the controller 22 has a function to search the memory 26 and transmit as a communication address response notification the IP address of a private branch exchange 2 to be a registration destination which is correlated with the MAC address of the newly installed IP telephone 3.

Further, the timer 24 is a time measuring means. When the controller 22 has received a communication address request notification, it starts the timer 24. A predetermined time is measured by this timer 24. The controller 24 transmits a communication address response notification after delay of the predetermined time (temporary waiting). When the controller 22 receives other communication address response notification from other private branch exchange 2 or IP telephone 3 while the above communication address response notification is delayed, it quits the transmission of the communication address response notification. In this manner, the controller 22 waits for a predetermined time after it has received a communication address request notification, thereby preventing collision between packets due to simultaneous delivery of the communication address response notifications onto the networks W1 and W1.

A range of the delay time measured by the timer 24 is, for example, from 0 second to 1.0 seconds for each private branch exchange 2. The delay time can be selected randomly from this range. For example, the delay time can be set to 0.1 seconds, 0.2 seconds, . . . , and the like sequentially from a high rank of the system. The set delay time is stored in the memory 26 as an information table of the response delay time for the private branch exchange.

Moreover, with respect to a registration request notification that requests accommodation transmitted from an IP telephone 3, in a case in which the MAC address of an IP telephone 3 as a transmission source included in the registration request notification is in the exchange connecting information stored in the memory 26, if the IP address of a private branch exchange 2 correlated with this MAC address is the MAC address of other private branch exchange 2, the controller 22 sends back a response notification indicating that registration of the IP address is not allowed. Further, if the IP address is that of the private branch exchange itself, the controller has a function to transmit a response notification indicating that the registration is allowed.

<Configuration of IP Telephone>

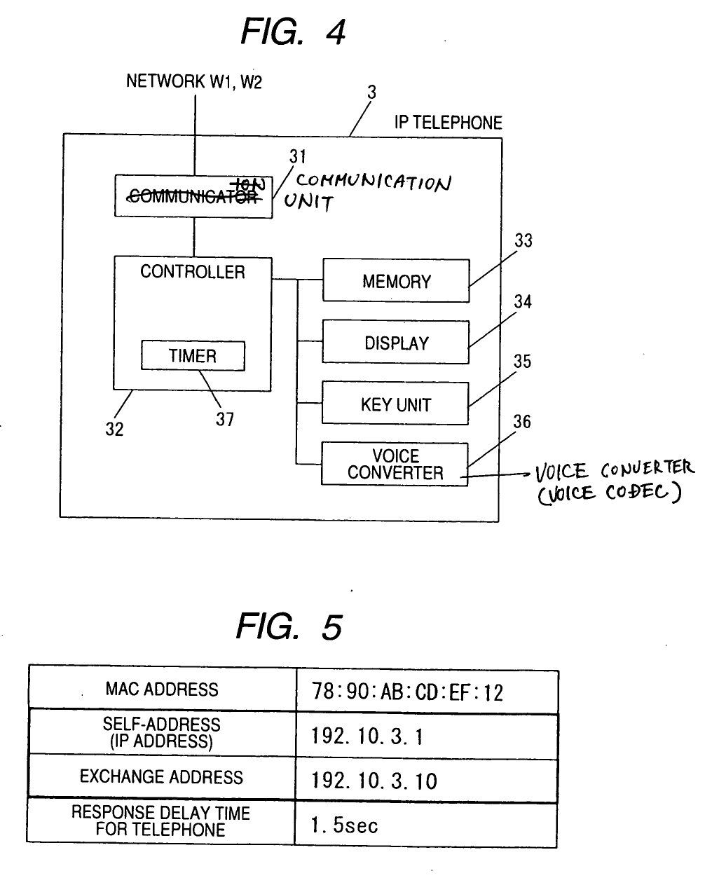

Next, the configuration of an IP telephone 3 that is an example of the terminal equipments to be accommodated by the private branch exchange system according to the embodiment of the present invention will be described with reference to FIG. 4. FIG. 4 is a block diagram showing the configuration of each IP telephone of FIG. 1. As shown in FIG. 4, the IP telephone 3 has a terminal communicator 31 (hereinafter abbreviated to as communication unit) that is connected with the networks W1 and W2, a display 34, a key unit 35, a voice converter 36, a terminal memory 33 (hereinafter abbreviated to as memory), a terminal controller 32 (hereinafter abbreviated to as controller), and a terminal timer 37 (hereinafter abbreviated to as timer).

The communication unit 31 communicates with the private branch exchanges 2 or other IP telephones 3 over the networks W1 and W2. When the IP telephone 3 communicates with the private branch exchanges 2 and other IP telephones 3 by unicast or broadcast, the IP telephone 3 is instructed from the controller 32 on which of unicast and broadcast is to be used, and then it performs communication via the communication unit 31. In addition, the communication unit 31, which is an interface for connection to the LANs described at the beginning, can be implemented using publicly known and publicly used network interfaces. Therefore, details of the internal configuration thereof are omitted herein.

The display 34 is a liquid crystal display panel which displays a transmission destination telephone number input from the key unit 35, a transmission source telephone number there is an incoming call, etc. The key unit 35 includes numeric keys for input of dial numbers, and function keys to which pickup, holding, redialing, etc. are allocated. The voice codec 36 has a function to convert speech voice data received via the communication unit 31 into a voice that is an analog signal (decoder), or to convert input voice into voice data to notify the controller 32 of the voice data (coder).

Similar to the private branch exchange 2, the memory 33 is composed of a volatile memory, a nonvolatile memory, and a peripheral control circuit. Both of the memories have a small capacity, and are collectively and generically called memory 33. The volatile memory is used to store operating programs and various kinds of setting data for primary storage of data. The nonvolatile memory is similar to that of the private branch exchange 2 in that it is used to store control programs and setting information. As the setting information, for example, IP addresses that are communication addresses of the IP telephones 3, and IP addresses of the private branch exchanges 2 of the registration destinations that are transmission destination addresses at the time of a call are stored.

The controller 32 communicates with a private branch exchange 2 as a registration destination via the communication unit 31 to call a transmission destination with a telephone number input from the key unit 35 or to transmit a speech from the voice converter 36 as a speech data, or to notify the voice converter 36 of the voice data from the private branch exchange 2. Further, the controller 32 has a function to transmit the IP address of a private branch exchange 2 as a registration destination which is stored in the memory 33 when it receives a communication address request notification from other IP telephone 3.

The controller 32 includes the timer 37 that is a time measuring means. This controller is similar to that of the private branch exchange 2 in terms of hardware configuration. When the controller 32 has received a communication address request notification, it starts the timer 37. A predetermined time is measured by this timer 37. The controller 32 transmits a communication address response notification after delay of the predetermined time. The operation of the controller 32 using the timer 37 is similar to that of the private branch exchange 2.

Moreover, the controller 32 controls the operation when it has received a restart request notification from the private branch exchange 2. When the controller has received a restart request notification, an IP telephone 3 returns to its initial state and transmits a registration request notification that requests accommodation by using as a transmission destination the IP address of the private branch exchange 2 stored in the memory 33. This registration request notification can also be transmitted as an operator manipulates the key unit 35 except that it is transmitted by taking as a trigger an event that the controller has received a restart request notification from the private branch exchange 2. Here, when the controller 32 has received a restart request notification, the controller 32 transmits a registration request notification. Thus, it is desirable to take a restart request notification from the private branch exchange 2 as a trigger.

FIG. 5 is a table showing an example of information stored by the memory of FIG. 4. The contents of the information stored by the memory 33 of the IP telephone 3a are shown in FIG. 5. Allocated “192.10.3.1” is stored in the memory 33 as the self-address of the IP telephone 3a, and “192.10.3.10” is stored as the IP address of the private branch exchange 2a as the registration destination. Further, the self-MAC address “78:90:AB:CD:EF:12”, and a response delay time table for the telephone are stored at the time of shipment as a product (before connection of the product to the private branch exchange system 1). The MAC address of the IP telephone 3 is stored in the memory 33.

A predetermined range of the delay time measured by the timer 37 is, for example, from 1.0 second to 4.0 seconds. The delay time can be an arbitrary time selected randomly from this range. For example, when the delay time has been completely registered with the private branch exchanges 2 as the registration destinations, a shortest delay time value of the IP telephones 3 can be seen. For example, in the case of the above-mentioned private branch exchange 2, it can be seen that the delay time is 1.0 seconds. Thus, the controller 32 counts the delay time in units of 0.1 seconds from a low-order digit value of the self-MAC address or the IP address to obtain 1.5 seconds, and stores it in the response delay time table for the telephone, thereby completing the setting. Each item of information described referring to FIG. 5 is generically referred to as the terminal connecting information.

<Operation of Private Branch Exchange System>

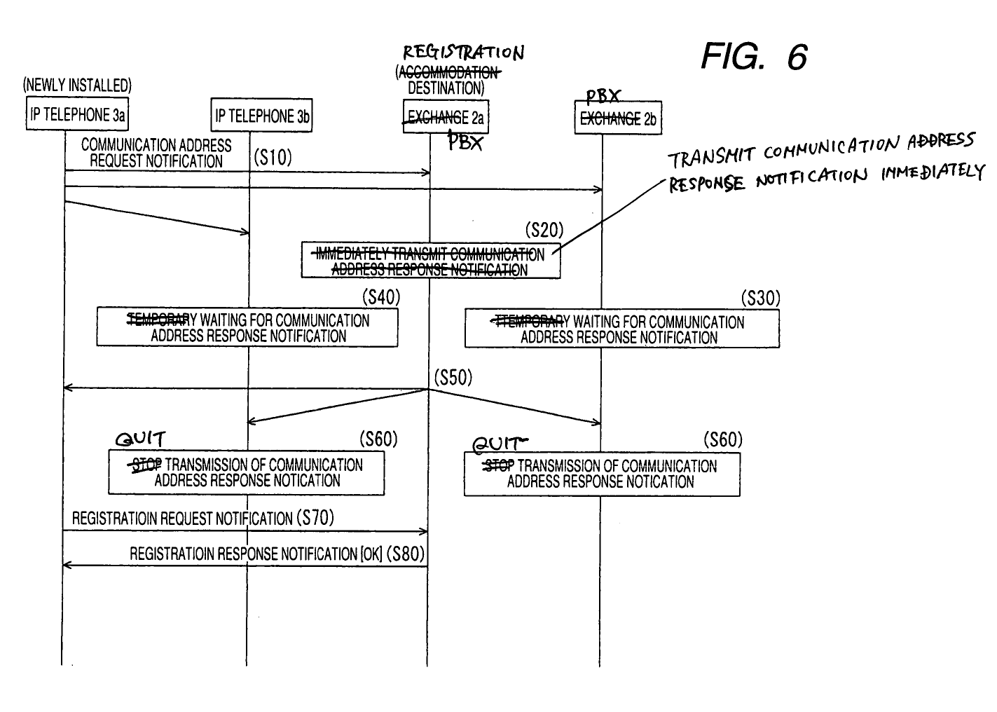

The operation of the private branch exchange system of the present invention configured as above will be described with reference to FIGS. 6 to 9. Here, the basic operation of the system when the IP telephone 3 a is adopted as a terminal unit to be newly installed and the private branch exchange 2a is adopted as the registration destination of the IP telephone will be described.

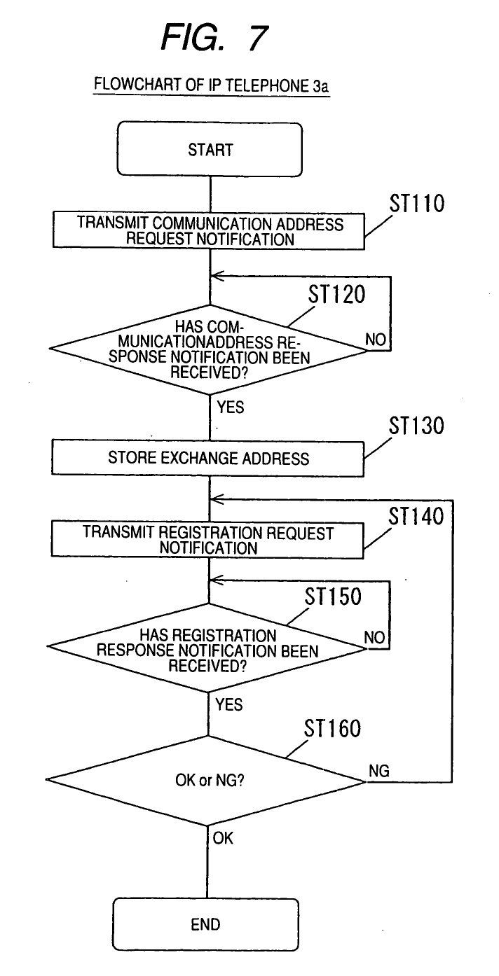

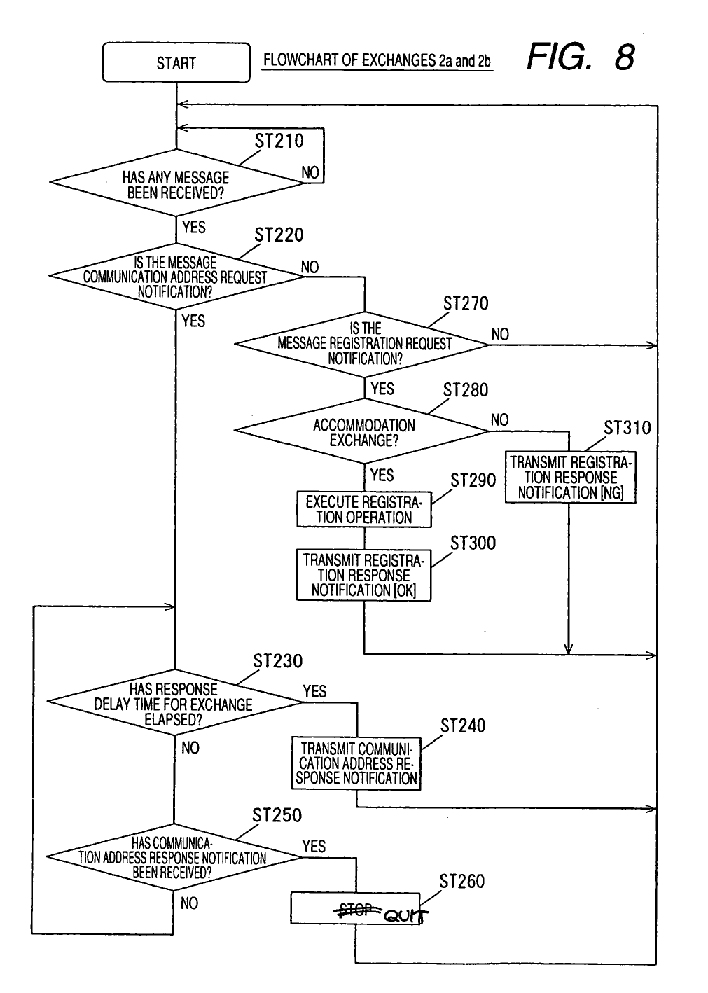

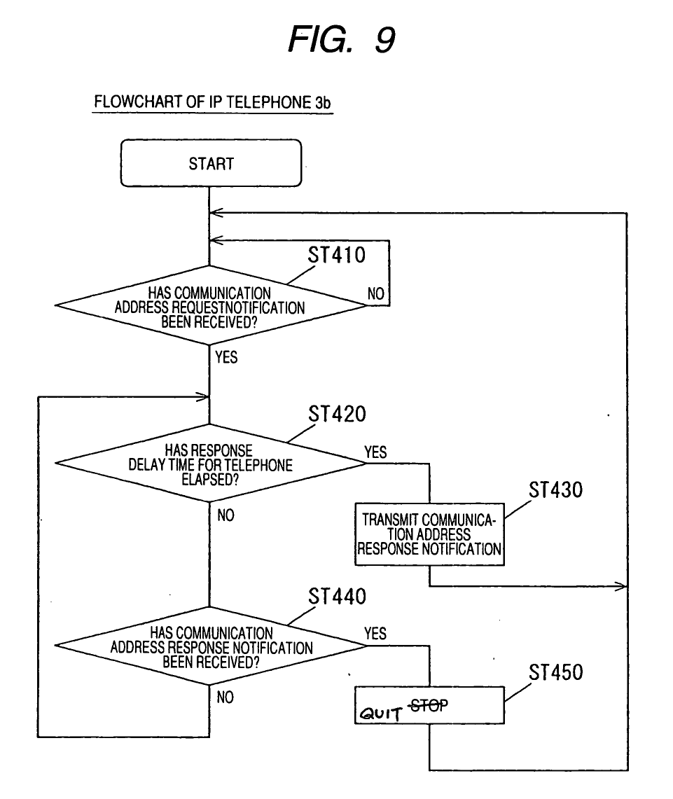

FIG. 6 is a sequence chart for explaining the operation of the private branch exchange system according to Embodiment 1. FIG. 7 is a flowchart for explaining the operation of an IP telephone to be newly installed in FIG. 6. FIG. 8 is a flowchart for explaining the operation of a private branch exchange in FIG. 6. FIG. 9 is a flowchart for explaining the operation of an existing IP telephone in FIG. 6.

As for the exchange connecting information stored in the memory 26 of each private branch exchange 2, as shown in FIG. 3B, it is assumed that the extension number, extension name, IP address, MAC address, etc. of the IP telephone 3a to be newly established have been completely set in the registration destination, i.e., the private branch exchange 2a, and the information within the memories 26 in the private branch exchanges 2b and 2c are updated and made the same contents by the communication between the private branch exchanges 2. It is also assumed that the IP address of the IP telephone 3a is allocated by a DHCP server which is not shown in FIG. 1 and set in the memory 33 of the IP telephone 3a.

In S10 of FIG. 6, first, a communication address request notification that is an acquisition request for the IP address of the private branch exchange 2a to be a registration destination is transmitted to the network W1 by broadcast from the IP telephone 3a (newly installed). That is, the controller 32 of the IP telephone 3 a transmits a communication address request notification to the network W1 by broadcast (Step ST110 of FIG. 7)

The private branch exchanges 2a and 2b confirm whether or not a certain message has been received over the network W1 (Step ST210 of FIG. 8). In the same broadcast domain, the private branch exchanges 2a and 2b are connected with the IP telephone 3b. Thus, each of the exchanges receives the communication address request notification (YES in Step ST210 of FIG. 8) (YES in Step ST220 of FIG. 8). Since the communication address request notification is transmitted by broadcast from the IP telephone 3a to be newly installed, the communication address request notification can reach the IP telephone 3b and the private branch exchange 2b even if the IP telephone 3a to be newly installed is not yet notified of the IP addresses of the existing IP telephone 3b and private branch exchange 2b.

Accordingly, since other terminal unit to be newly installed can be notified of the communication address of a private branch exchange to be a registration destination, communicating setting of the private branch exchange can be easily performed by requesting a registration by using the notified communication address of the private branch exchange as the registration destination. Further, since the communication address request notification is transmitted by broadcast from other terminal unit to be newly installed, the terminal unit to be newly installed can transmit the communication address request notification to a private branch exchanges as a registration destination and an existing terminal unit in the same broadcast domain.

Since the network W1 and the network W2 are in different broadcast domains, a communication address request notification that has transmitted by broadcast from the IP telephone 3a cannot pass through the router 4. Therefore, the communication address request notification from the IP telephone 3a does not reach the private branch exchange 2c and the IP telephone 3c.

The controller 22 of the private branch exchanges 2a and 2b which have received the communication address request notification transmitted by the IP telephone 3 a determines whether or not the MAC address of the IP telephone 3 a that is a transmission source included in the transmission address request notification is within the exchange connecting information stored in the memory 26. Then, if the MAC address of the IP telephone 3a as the transmission source is within the exchange connecting information (private branch exchange 2a), the controller acquires from the memory 26 a private branch exchange IP address correlated with the number of a private branch exchange as a registration destination of the IP telephone 3a.

Accordingly, the communicating setting of the private branch exchanges can be easily performed with a simple configuration.

Then, the timer 24 of the controller 22 of the private branch exchange 2a measures delay time. At this time, if a preset time has elapsed (YES in Step ST230 of FIG. 8), the controller 22 transmits the IP address “192.10.3.10” of the private branch exchange 2a by broadcast while the address is included in a communication address response notification (Step in ST240 of FIG. 8). At this time, if the setting of the response delay time for the private branch exchange is zero second, the communication address response notification is transmitted immediately (S20).

Since the private branch exchange 2 determines on the basis of the MAC address that is the identity information of the IP telephone 3a whether the communication address response notification is to be transmitted, it is possible to prevent an unauthorized terminal unit from being erroneously notified of the IP address of the private branch exchange 2 as the registration destination, even if terminal equipments such as the IP telephones 3 which transmit the communication address request notification in an unauthorized manner are connected to the network W1. In a case in which the delay time (response delay time for the private branch exchange) for which a communication address response notification is transmitted is, for example, 0.5 seconds, the private branch exchange 2b waits for 0.5 seconds (S30) while 0.5 seconds are measured by the timer 24. That is, the private branch exchange 2b waits until the response delay time for the private branch exchange has elapsed (NO in Step ST230 of FIG. 8), and determines whether or not the communication address response notification has been received (Step ST250 of FIG. 8).

Accordingly, since the transmission of the connecting information to one terminal unit can be delayed until the response delay time has elapsed, the traffic of the networks can be kept from being concentrated simultaneously. Accordingly, an increase in the load of the networks can be prevented efficiently.

Moreover, since the measurement time of the timer (24, 37) is a time value that is calculated and determined based on the response delay time and the self-addresses of the private branch exchanges 2 (IP telephones 3) by the controller (22, 32), the delay time for which a communication address response notification is transmitted is more minutely dispersed. This can suppress the traffic of the networks.

The IP telephone 3b confirms whether or not it has received a communication address request notification (Step ST410 of FIG. 9). When the IP telephone 3b has received a communication address request notification (YES in Step ST410 of FIG. 9), the IP telephone 3b notifies the IP address of the private branch exchange 2a as the registration destination stored in the memory 33. In this case, similar to the private branch exchange 2b, the IP telephone 3b temporarily waits for a delay time having a value that is larger than 1.0 seconds, by using the timer 37 of the controller 32 (S40). That is, the IP telephone 3b waits until the response delay time for the private branch exchange has elapsed, and determines whether or not it has received the communication address response notification for this response delay time (Steps ST420 and ST440 of FIG. 9)

The communication address response notification transmitted from the private branch exchange 2a by broadcast reaches the IP telephone 3b and the private branch exchange 2b as well as the IP telephone 3a (S50). Here, if the timer 37 of the controller 32 of the IP telephone 3b measures a delay time and consequently a preset time has elapsed before a communication address response notification is received (YES in Step ST420 of FIG. 9), the controller 32 transmits the IP address “192.10.3.10” of the private branch exchange 2a by broadcast while the IP address is included in the communication address response notification (Step ST430 of FIG. 9).

The IP telephone 3b and the private branch exchange 2b which has received the communication address response notification transmitted from the private branch exchange 2a (YES in Step ST250 of FIG. 8) (YES in Step ST440 of FIG. 9) quits transmission of the communication address response notification (S60) (Step ST260 of FIG. 8) (Step ST450 of FIG. 9). Since the IP telephone 3b and the private branch exchange 2b receive the communication address response notification transmitted from the private branch exchange 2a to thereby quit transmission of a communication address response notification expected to be transmitted, extra notifications can be prevented from being transmitted to the network W1. Accordingly, an increase in the amount of traffic can be suppressed.

Accordingly, transmission of the connecting information expected to be transmitted by the unit itself is quited, when any information is received from other units for this predetermined time. Thus, an increase in the load of the networks can be prevented.

Further, the delay time when a communication address response notification is transmitted by the private branch exchange 2a, the private branch exchange 2b and the IP telephone 3b is set to be different ranges. Accordingly, since the delay time is set to be different ranges even if the delay time is a random value, the delay time is determined within the ranges. Also, since the range is set such that the range of the private branch exchanges 2 is shorter than the range of the IP telephones 3, a communication address response notification is necessarily transmitted from the private branch exchange 2. Accordingly, since a communication address response notification from the IP telephones 3 which are connected much more than as the private branch exchanges 2 is deterred, it is possible to suppress extra communication address response notifications which may be transmitted due to delay of processing of a response after the communication address response notification is received.

The controller 32 of the IP telephone 3a which has received the IP address of the private branch exchange 2a by the communication address response notification stores the IP address “192.10.3.10” of the private branch exchange 2a as the address of a private branch exchange to be a registration destination in the memory 33 (Step ST120 and Step S130 of FIG. 7).

The controller 32 of the IP telephone 3a transmits a registration request notification using this IP address as the transmission destination address to the private branch exchange 2a by unicast (S70) (Step ST140 of FIG. 7). If the private branch exchange 2a or 2b has received a certain message over the network W1 (YES in Step ST210 of FIG. 8) and the message is not a communication address request notification (NO in Step ST220 of FIG. 8), the private branch exchanges 2a and 2b determines whether or not the message is a registration request notification (Step ST270 of FIG. 8). Here, since the registration request notification is transmitted to the private branch exchange 2a, the private branch exchange 2a determines that the received message is a registration request notification (YES in Step ST270 of FIG. 8).

Then, the private branch exchange 2a confirms on the basis of the registration request notification transmitted from the IP telephone 3a whether or not the IP telephone 3a is an IP telephone corresponding to the registration request (Step ST280 of FIG. 8).

If the private branch exchange 2a determines that the IP telephone 3a is an IP telephone corresponding to the registration request notification (YES in Step ST280 of FIG. 8), the private branch exchange 2a registers with the memory 26 an event that the IP telephone 3a is connected to a line under the private branch exchange 2a itself (that is, the private branch exchange starts to operate). Then, a registration response notification (OK) indicative of completion of registration is transmitted to the IP telephone 3a (S80) (Steps ST290 and ST 300 of FIG. 8). On the other hand, if the private branch exchange 2a determines that the IP telephone 3a is not an IP telephone corresponding to the registration request notification (NO in Step ST280 of FIG. 8), a registration response notification (NG) indicative of no allowance of registration is transmitted to the IP telephone 3a (Step ST310 of FIG. 8).

If the controller 32 of the IP telephone 3a has received a registration response notification from the private branch exchange 2a (YES in Step ST150 of FIG. 7), the controller determines whether the registration response notification is a notification indicative of OK of registration or NG of notification (Step ST160 of FIG. 7).

If the registration response notification indicates NG of registration (NG in Step S160), the controller 32 of the IP telephone 3a repeats the processing of Steps ST140 to ST160. On the other hand, If the registration response notification indicates OK of registration (OK in Step S160), the IP telephone 3a completes the processing of registration to the private branch exchange system 1. When the registration of the IP telephone 3a is completed in the private branch exchange 2a, the private branch exchange 2a starts a control that performs a notification to the IP telephone 3a when there is any incoming call to the IP telephone 3a.

As described above, in the IP telephone 3a to be newly installed, if the MAC address of the IP telephone 3a is correlated with the IP address of the private branch exchange 2a to be a registration destination and is within the exchange connecting information of the private branch exchange 2a, the IP telephone 3a to be newly installed is notified of the IP address of the private branch exchange 2a to be a registration destination from the private branch exchange 2a to be a registration destination. The IP telephone 3a to be newly established sets the notified IP address of the private branch exchange 2a as a registration destination, whereby manual setting of the private branch exchange 2a becomes unnecessary. Accordingly, erroneous setting of the private branch exchange 2a of the private branch exchange system 1 can be prevented.

Moreover, since the communication address response notification can be transmitted by any private branch exchange as long as the exchange connecting information is stored in a memory of the exchange, even in a private branch exchange to be a registration destination and even in other private branch exchanges not to be a registration destination, the communication address response notification can be transmitted to the terminal equipments. Further, since a registration response notification including connecting information is transmitted by unicast, the load of the networks can be prevented from increasing.

Further, if the communication unit has not received other communication address response notification, a communication address response notification including the address of a private branch exchange to be a registration destination is transmitted by broadcast. Thus, wasteful transmission of the communication address response notification can be reduced, and thereby the load of the networks can prevented from increasing.

### Embodiment 2

In Embodiment 1, there is described the example in which the delay time when a communication address response notification is transmitted is shorter in the private branch exchange 2a to be a registration destination than in the private branch exchange 2b. That is, in Embodiment 1, the private branch exchange 2a to be a registration destination of the IP telephone 3a transmits the communication address response notification.

In Embodiment 2, an example in which the delay time when a communication address response notification is transmitted is longer in the private branch exchange 2a to be a registration destination than in the private branch exchange 2b will be described. In addition, since the configuration of the private branch exchange system 1 of Embodiment 2 is the same as the configuration of the private branch exchange system 1 (FIGS. 1 to 5) described in Embodiment 1, the description thereof is omitted herein.

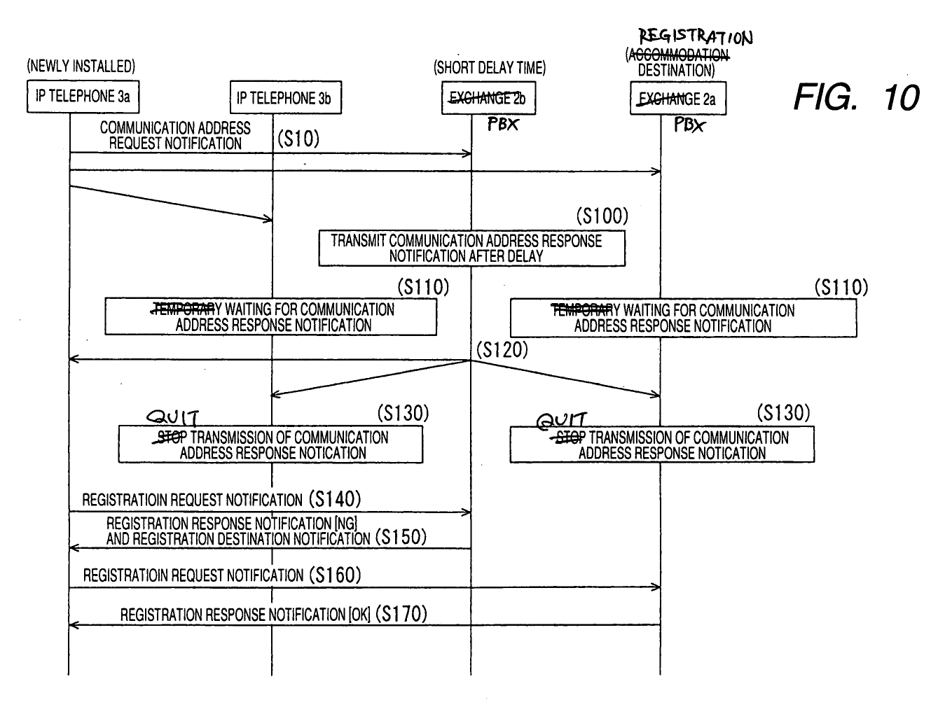

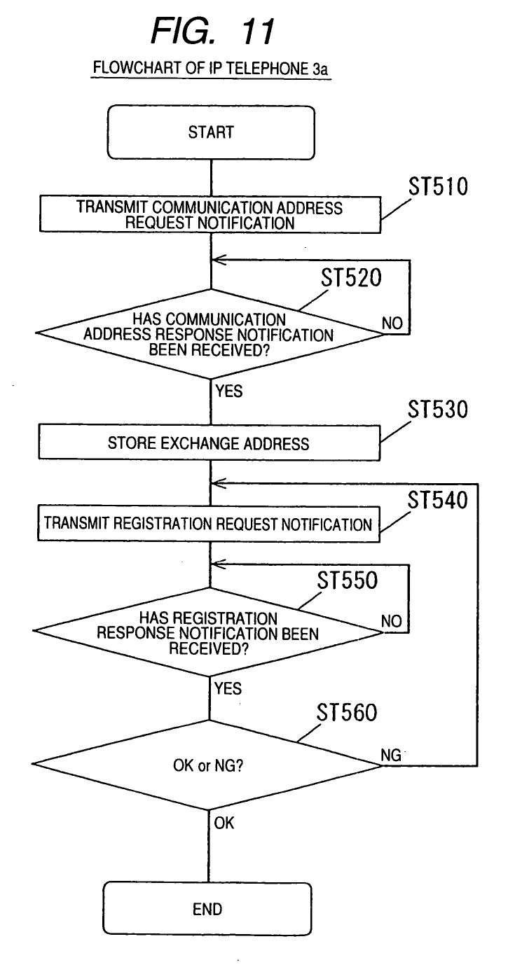

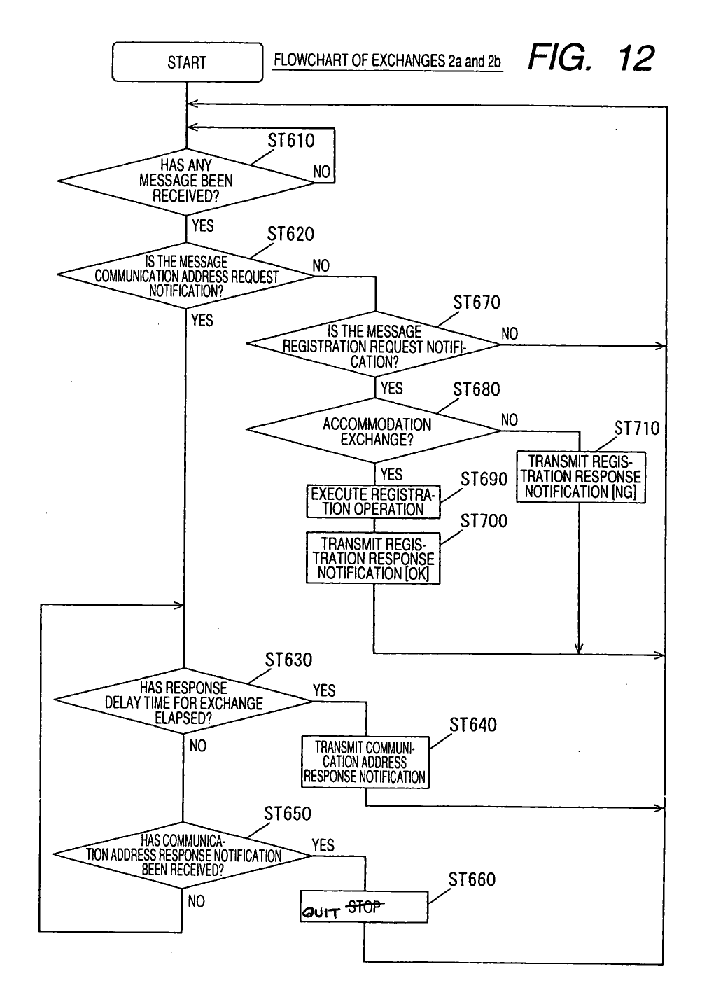

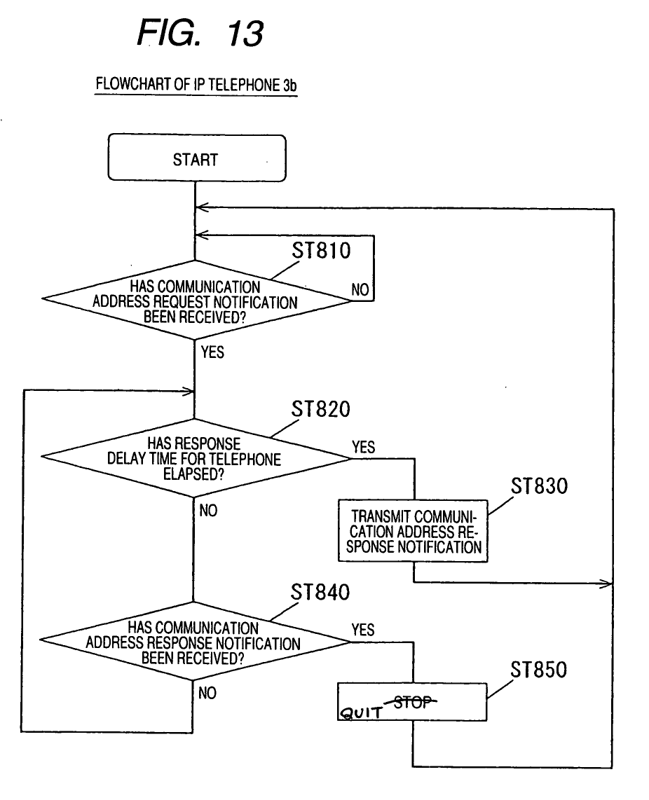

FIG. 10 is a sequence chart for explaining the operation of the private branch exchange system according to Embodiment 2 of the present invention. FIG. 11 is a flowchart for explaining the operation of an IP telephone to be newly installed in FIG. 10. FIG. 12 is a flowchart for explaining the operation of a private branch exchange in FIG. 10. FIG. 13 is a flowchart for explaining the operation of an existing IP telephone in FIG. 10.

In addition, in the operation of the following private branch exchange system 1, the description of the same operation as the private branch exchange system 1 of Embodiment 1 is omitted. In addition, respective operations of Steps ST510 to ST560 shown in FIG. 11 correspond to the processing of Steps ST110 to ST160 shown in FIG. 7.

Further, respective operations of Steps ST610 to ST710 shown in FIG. 12 correspond to the processing of Steps ST210 to ST310 shown in FIG. 8, and respective operations of Steps ST810 to ST850 shown in FIG. 13 correspond to the processing of Steps ST410 to ST450 shown in FIG. 9.

Since the operation of S10 in FIG. 10 is the same as the operation of S10 in FIG. 6 in which the IP telephone 3a transmits a communication address request notification, the description thereof is omitted herein. The controller 22 of the private branch exchange 2b which has received the communication address request notification measures a delay time by the timer 24 of the controller 22. If the measurement time by the timer 24 is a time that a preset time has elapsed, the controller 22 transmits the IP address “192.10.4.10” of the private branch exchange 2b by broadcast while the address is included in a communication address response notification (S100).

Since the delay time when a communication address response notification is transmitted is longer in the private branch exchange 2a than in the private branch exchange 2b, the private branch exchange 2a is put in a temporary waiting state (S110). That is, the private branch exchange 2a temporarily waits until the response delay time for the private branch exchange has lapsed, and determines whether or not a communication address response notification has been received for this delay time. Further, since the IP telephone 3b has a longer range of delay time than the private branch exchanges 2a and 2b, the IP telephone is delayed (temporary waiting) till a period of time slower than the private branch exchange 2a (S110).

Since the communication address response notification transmitted from the private branch exchange 2b is transmitted by broadcast, it reaches the private branch exchange 2a and the IP telephone 3b as well as the IP telephone 3a (S120). The controller 32 of the IP telephone 3a which has received the IP address of the private branch exchange 2a by the communication address response notification from the private branch exchange 2b stores in the memory 33 the IP address of the private branch exchange 2a as the address (IP address “192.10.4.10”) (see FIG. 3) of a private branch exchange to be a registration destination.

The IP telephone 3b and the private branch exchange 2a which have received the communication address response notification transmitted from the private branch exchange 2b quits transmission of the communication address response notification (S130). The IP telephone 3a notifies the private branch exchange 2b of a registration request (S140).

The private branch exchange 2b determines whether or not the MAC address of the IP telephone 3a that is a transmission source included in the registration request notification is within the exchange connecting information stored in the memory 26. Then, the private branch exchange 2b determines based on the exchange connecting information that the MAC address of the IP telephone 3a as the transmission source does not exist in the exchange connecting information of the exchange itself, but is correctly the private branch exchange 2a. Then, the private branch exchange 2b acquires the IP address of a private branch exchange associated with the number of a private branch exchange to be an authorized registration destination of the IP telephone 3a. Then, the private branch exchange 2b transmits to the IP telephone 3a the IP address of the authorized private branch exchange 2a along with a registration response notification (NG) indicating that registration to the private branch exchange 2b is NG (S150).

The IP telephone 3a which has acquired the IP address of the authorized private branch exchange 2a transmits a registration request notification to the private branch exchange 2a by broadcast (S160). The private branch exchange 2a determines whether or not the MAC address of the IP telephone 3a that is a transmission source included in the registration request notification is in the exchange connecting information stored in the memory 26. Then, the private branch exchange 2a determines based on the exchange connecting information that the MAC address of the IP telephone 3a as the transmission source exists within the exchange connecting information of the private branch exchange itself. Then, private branch exchange 2a registers the IP telephone 3a in its own exchange connecting information, and then transmits to the IP telephone 3a a registration response notification (OK) indicating that the registration is authorized (S170).

### Embodiment 3

As described above, as for the exchange connecting information that is stored by the private branch exchange 2a to be a registration destination of the IP telephone 3a to be newly installed, the private branch exchange 2b which is not the registration destination stores the exchange connecting information of the same contents as the registration destination. Thus, the address of the private branch exchange to be a registration destination can be transmitted by the private branch exchange 2b instead of the private branch exchange 2a. This means that, for example, even in a case in which a private branch exchange to be a registration destination of the IP telephone 3a is the private branch exchange 2c to be connected via the router 4, the private branch exchange 2c can transmit the address of the private branch exchange 2a to be an registration destination of the private branch exchange 3a instead of the private branch exchange 2a. Accordingly, even if the IP telephone 3a is in a broadcast domain different from the private branch exchange 2c as a registration destination, the private branch exchange 2b having the same exchange connecting information as the private branch exchange 2c can notify the IP telephone 3a of the IP address of the private branch exchange 2c as a registration destination as long as the private branch exchange 2b exists in the same broadcast domain as the private branch exchange 2c.

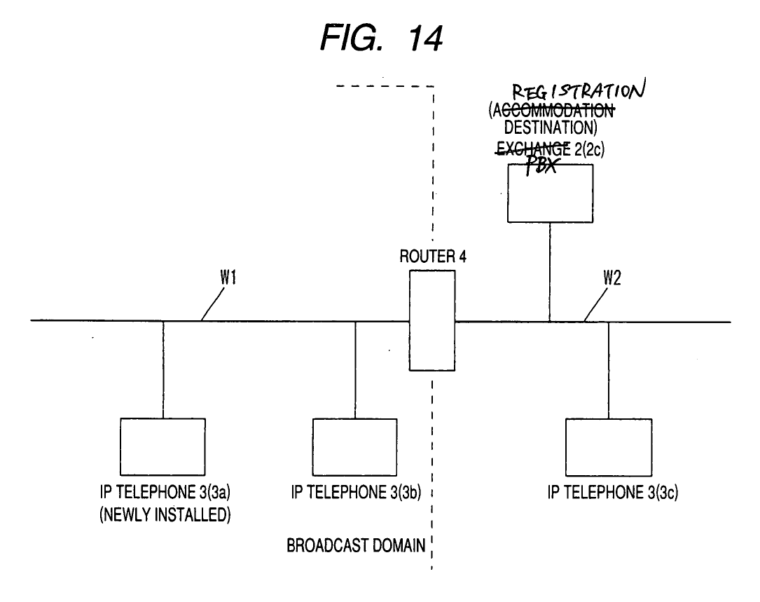

In Embodiment 3, a case in which the private branch exchange 2 is not connected to the network W1 having the same broadcast domain as the IP telephone 3a to be newly installed will be described with reference to FIG. 14 to FIG. 17.

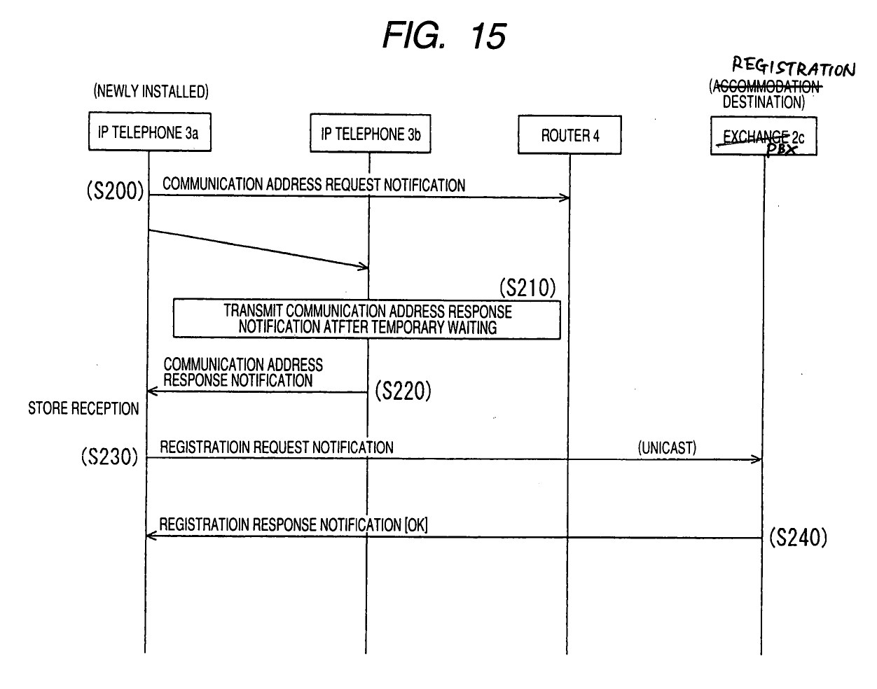

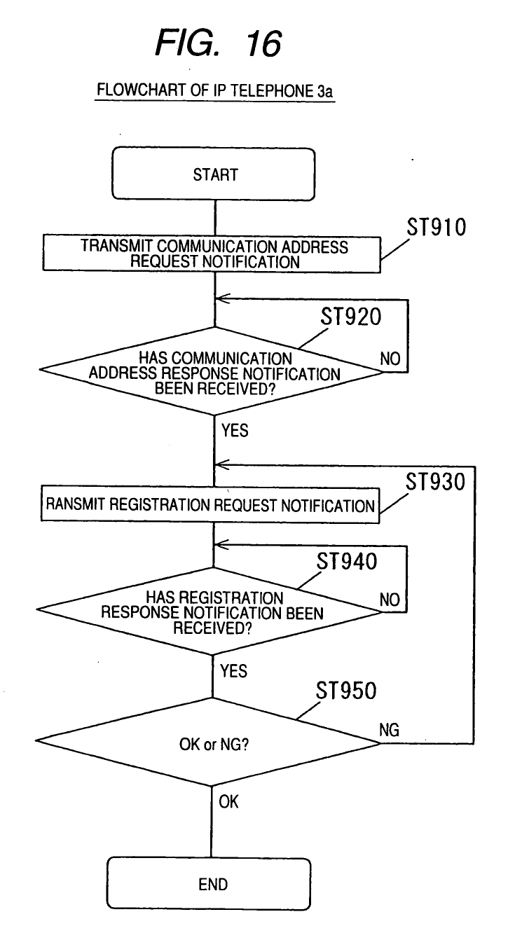

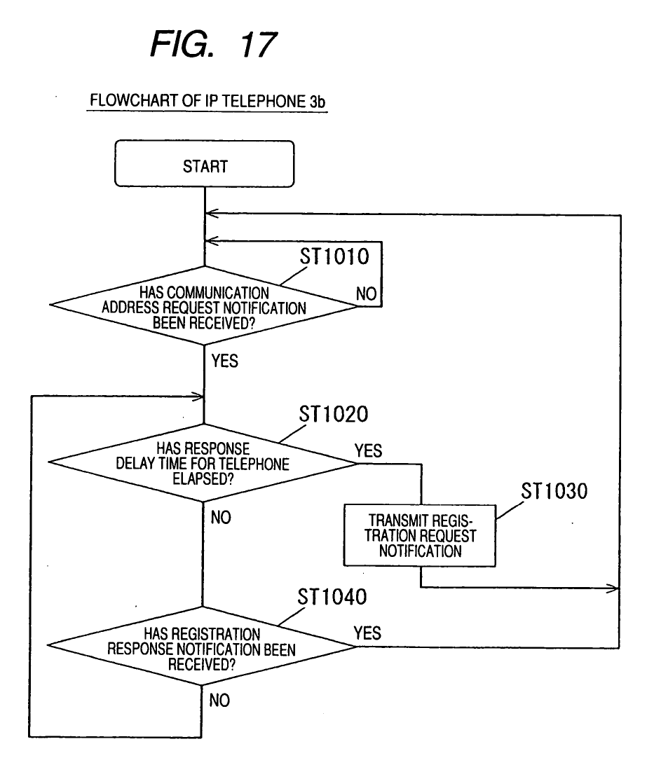

FIG. 14 is a block diagram showing the configuration of a private branch exchange system according to Embodiment 3 of the present invention. FIG. 15 is a sequence chart for explaining the operation of the private branch exchange system of FIG. 14. FIG. 16 is a flowchart for explaining the operation of a newly installed IP telephone in FIG. 14. FIG. 17 is a flowchart for explaining the operation of an existing IP telephone in FIG. 14. In addition, the components in FIGS. 14 to 17 having the same functions and operations as those of the private branch exchange system 1 in Embodiment 1 are designated by the same reference numerals, and the description thereof is omitted herein.

As shown in FIG. 14, it is assumed that the IP telephone 3a to be newly installed is accommodated in the private branch exchange 2c. It is also assumed that the private branch exchange 2c already accommodates the IP telephones 3b and 3c. Moreover, since the IP telephone 3b is accommodated in the private branch exchange 2c via the router 4, the IP telephone 3a to be newly installed has the private branch exchange 2c as a registration destination existing outside the broadcast domain.

First, a communication address request notification that is an acquisition request for the IP address of the private branch exchange 2c to be a registration destination is transmitted to the network W1 by broadcast from the IP telephone 3a (S200) (Step ST910 of FIG. 16). Since the IP telephone 3b is connected in the same broadcast domain as the IP telephone 3a, the IP telephone 3b can receive the communication address request notification (YES in Step ST1010 of FIG. 17). On the other hand, since the private branch exchange 2c is in the broadcast domain different from the IP telephone 3a, a communication address request notification transmitted by broadcast from the IP telephone 3a does not reach the private branch exchange 2c (see FIGS. 14 and 15).

Since the IP address of the private branch exchange 2c as a registration destination is stored in the memory 33 of the IP telephone 3b which has received the communication address request notification from the IP telephone 3a, the IP telephone 3b tries to notify this IP address as a communication address response notification. However, since transmission of the response notification is delayed as described above (refer to the description of the timer 37 in Embodiment 1), the IP telephone 3b waits temporarily (S210).

Since the private branch exchange 2c is not connected to the network within the same broadcast domain even if the IP telephone 3b temporarily waits the transmission of the communication address response notification, the IP telephone 3b does not receive the communication address response notification even if a predetermined time has elapsed (YES in Step ST1020 of FIG. 17). That is, in Embodiment 3, while the IP telephone 3b waits temporarily, an operation (NO in Step ST 1020 of FIG. 17) (Step ST 1040 of FIG. 17) which receives a communication address response notification is not performed.

The IP telephone 3b which has passed a predetermined time transmits the IP address “192.10.4.10” (see FIG. 3) of the private branch exchange 2c stored in the memory 33 by broadcast as a communication address response notification (S220) (Step ST1030 of FIG. 17). Then, the IP telephone 3a receives the IP address of the private branch exchange by the communication address response notification from the IP telephone 3b (YES in Step ST920 of FIG. 16). The controller 32 of the IP telephone 3a stores in the memory 33 the IP address “192.10.4.10” of the private branch exchange 2c as the address of a private branch exchange to be a registration destination.

The IP telephone 3a transmits a registration request notification by broadcast by using the IP address of the private branch exchange 2c to be a registration destination as a transmission destination address, on the basis of the communication address response notification (Step ST930 of FIG. 16). Since this registration request notification is transmitted by broadcast by using the IP address of the private branch exchange 2c as a transmission destination address, it can pass through the router 4 and then reach the private branch exchange 2c even in a different broadcast domain.

The private branch exchange 2c responds to the registration request notification transmitted from the IP telephone 3a and then transmits a registration response notification (OK) indicative of completion of registration to the IP telephone 3a by broadcast (S240).

If the IP telephone 3a has received the registration response notification from the private branch exchange 2c (YES in Step ST940 of FIG. 16), it determines whether or not this registration response notification indicates the completion of registration (OK or NG) (Step ST950). Here, since a registration response notification (OK) indicative completion of registration is transmitted to the IP telephone 3 a from the private branch exchange 2c, the IP telephone 3a determines that the registration response notification is the registration response notification (OK) indicative of completion of registration (OK in Step ST950). If the processing of registration of the IP telephone 3a is completed in the private branch exchange 2c, the private branch exchange 2c starts a control that performs a notification to the IP telephone 3a when there is a call to IP telephone 3a.

As described above, even if the private branch exchange 3c as a registration destination is connected not to the network W1 in the same broadcast domain as the IP telephone 3a to be newly installed but to the network W2 in a different broadcast domain, the private branch exchange 3c can be notified of the IP address of the private branch exchange 2c to be a registration destination from an IP telephone 3 having the same registration destination as the IP telephone 3a, if only the IP telephone 3 having the same registration destination is within the same broadcast domain. Accordingly, manual setting of the private branch exchange 2c becomes unnecessary by setting the notified IP address of the private branch exchange 2c as a registration destination. This makes it possible to prevent erroneous setting of the private branch exchange 2c in the private branch exchange system 1.

In Embodiment 3, there has been described the case in which the IP telephone 3b instead of the private branch exchange 2c notifies the IP telephone 3a of the IP address of the private branch exchange 2c to be a registration destination because the private branch exchange 2c is not connected to the same broadcast domain as the IP telephone 3a to be newly installed. For example, if the private branch exchange 2c to be a registration destination is within the same broadcast domain, a communication address response notification from the IP telephone 3b to the IP telephone 3a becomes unnecessary because the delay time when a communication address response notification is transmitted is made shorter in the private branch exchange 2c than in the IP telephone 3b.

However, for example, even in a case in which the private branch exchange 2c to be a registration destination is connected to the same broadcast domain and it cannot transmit a communication address response notification, the IP telephone 3b has a function to transmit the communication address response notification, whereby the IP telephone 3b can transmit the communication address response notification instead of the private branch exchange 2c. Therefore, it is possible to avoid unnecessarily considering functions or installation types that transmit a communication address response notification in introduction of the private branch exchange 2c.

### Embodiment 4

In Embodiments 1 to 3, there has been described the case in which an IP telephone 3 is newly established within the private branch exchange system 1. In Embodiment 4, a case in which an IP telephone 3 is relocated within the private branch exchange system 1.

The relocation of an IP telephone 3 within the private branch exchange system 1 includes a case (positional change) in which an accommodated private branch exchange 2 is changed by changing the installation position of an IP telephone 3 and a case (registration destination change) in which the installation position of an IP telephone 3 is not changed but a private branch exchange 2 as a registration destination is changed.

The former case in which the installation position of an IP telephone 3 is changed corresponds to a case in which, when a user who uses the IP telephone 3 moves to any other building, he/she moves with the IP telephone 3. In such a positional change, the operation of the IP telephone 3b to be newly connected is the same as the operation of Embodiment 3.

The latter case, i.e., the registration destination change in which a private branch exchange 2 as a registration destination of an IP telephone 3 is changed corresponds to a case in which the position of a user's office is not changed, but as a department to which the user belongs is changed, a group to which the IP telephone 3 belongs is also changed to other group which is accommodated by other private branch exchange 2.

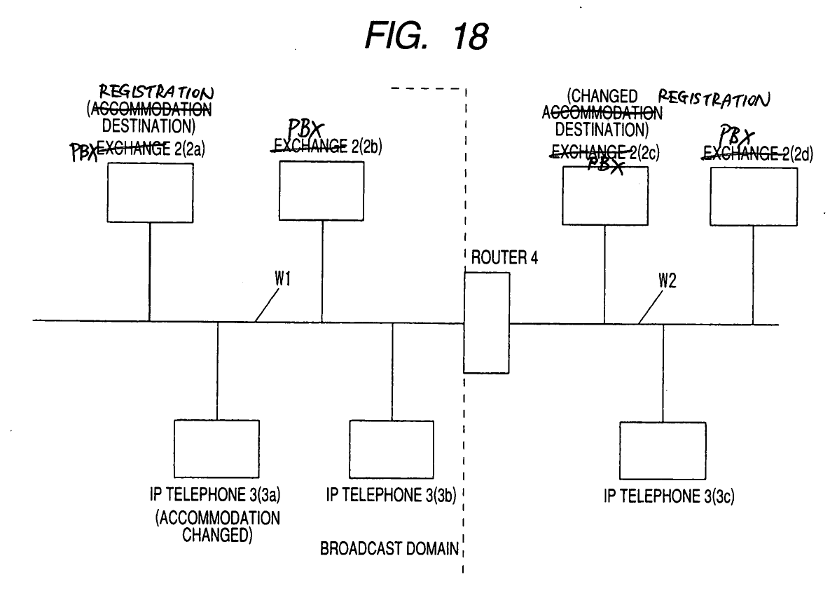

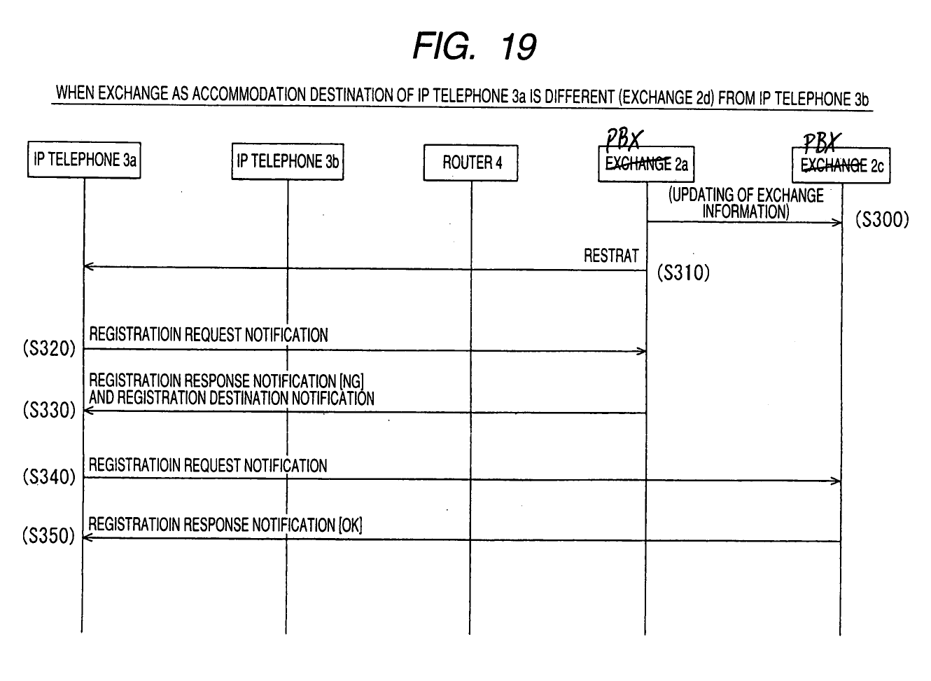

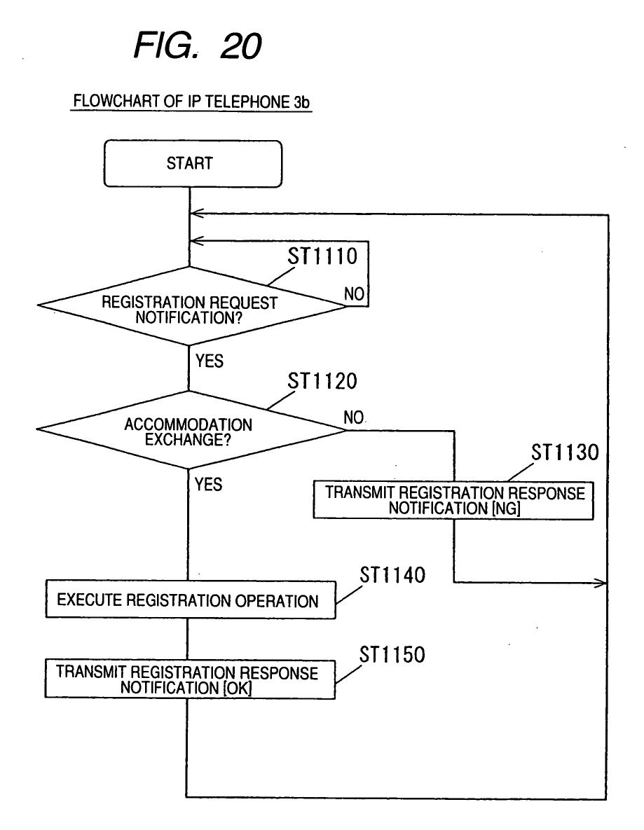

In Embodiment 4, the latter case in which the installation position of an IP telephone 3 is not changed but a private branch exchange 2 as a registration destination is changed will be described. FIG. 18 is a block diagram showing the configuration of a private branch exchange system according to Embodiment 4 of the present invention. FIG. 19 is a sequence chart for explaining the operation of the private branch exchange system of FIG. 18. FIG. 20 is a flow chart for explaining the operation of a private branch exchange in FIG. 18. In addition, the components in FIGS. 18 to 20 having the same functions and operations as those of the private branch exchange system 1 in Embodiment 1 are designated by the same reference numerals, and the description thereof is omitted herein.

As shown in FIG. 18, it is assumed that the IP telephone 3a has been accommodated in the private branch exchange 2a (registration destination), but it is changed to and newly accommodated in the private branch exchange 2c by changing (relocating) the registration destination. It is also assumed that, with the relocation (registration destination change) of the IP telephone 3a, the number of an accommodating private branch exchange of the exchange connecting information stored in the memory 26 of the private branch exchange 2a is changed and updated to the number indicative of the private branch exchange 2c as a new registration destination (refer to Embodiment 1). Also, the connecting information (IP address of a private branch exchange as an registration destination) of the IP telephone 3a is updated according to the following processing.

First, the private branch exchange 2a communicates with the private branch exchange 2c by setting of the relocation of the IP telephone 3a being performed, and transmits the exchange connecting information stored in the memory 26 to the private branch exchange 2c to thereby update the contents within the memory 26 (S300).

Then, the private branch exchange 2a transmits to the IP telephone 3a a restart request notification that instructs the IP telephone to restart (S310). In the IP telephone 3a which has received the restart request notification, the controller 32 brings the entire IP telephone 3a into an initial state, thereby performing an initialization operation. This initialization operation does not erase even the IP address of a private branch exchange to be a registration destination, and setting contents of function keys, which are stored in the memory 33. The controller 32, as its initialization operation, transmits a registration request notification by unicast by using the IP address of the private branch exchange 2a as a registration destination, as a transmission destination (S320) (Step ST110 of FIG. 20).

The private branch exchange 2a which has received the registration request notification determines whether or not the MAC address that is identity information of the IP telephone 3a included in the registration request notification is stored in the exchange connecting information (Step ST1120 of FIG. 20).

If the private branch exchange 2a determines based on the exchange connecting information that the registration destination of the IP telephone 3a is the private branch exchange 2c (NO in Step ST1120), the IP telephone 3a transmits the information indicative of no allowance of registration with the private branch exchange 2a, and the IP address “192.10.4.10” of the private branch exchange 2c as a registration destination to the IP telephone 3a as a registration response notification (NG) (S330) (Step ST1130 of FIG. 20).

Since the private branch exchange 2a confirms that the MAC address of the IP telephone 3a exists in the exchange connecting information, it is possible to prevent an unauthorized unit from being erroneously notified of the IP address of the private branch exchange 2 as an registration destination, even if terminal equipments such as the IP telephones 3 which transmit the registration request notification in an unauthorized manner is connected to the network W1.

The IP telephone 3a which has been notified of the IP address “192.10.4.10” of the private branch exchange 2c as a new registration destination transmits a registration request notification to the private branch exchange 2c that is the IP address (S340).

The private branch exchange 2c which has received the registration request notification determines whether or not the MAC address that is identity information of the IP telephone 3a included in the registration request notification is stored in the exchange connecting information (Step ST1120 of FIG. 20).

Since the exchange connecting information of the private branch exchange 2c is updated to the same contents as the private branch exchange 2a in S300, it can be recognized that the IP telephone 3a is an IP telephone to be accommodated in the private branch exchange 2c (YES in Step ST1120 of FIG. 20)

The private branch exchange 2c performs registration processing of the IP telephone 3a on the basis of the registration request notification transmitted from the IP telephone 3a (Step ST1150 of FIG. 20). If the registration of the IP telephone 3a with the private branch exchange 2c is completed, the private branch exchange 2c starts a control that performs a notification to the IP telephone 3a when there is any incoming call to the IP telephone 3a.

Since the communication processing performed in Steps S330 and S350 is unicast processing that specifies and transmits the IP address of other party as a communication destination, a notification can reach the other party as a communication destination in a case in which the notification is performed in the same broadcast domain or even in a case in which the notification is performed in a different broadcast domain via a router 4. Accordingly, an IP telephone 3 to be relocated can be notified of the IP address of a private branch exchange 2 as a registration destination without any restriction on networks. In this manner, since the IP address of a private branch exchange as a destination to which an IP telephone 3 is to be relocated can be set without any manual setting on the side of the IP telephone 3, the relocation work of the IP telephones 3 can be performed easily.

Although Embodiments 1 to 4 of the present invention have been described hitherto, the present invention is not limited to the above-described Embodiments 1 to 4. For example, although the private branch exchange 2a and the private branch exchange 2b are separately configured referring to FIG. 1, separately configured slot cards may be mounted on one private branch exchange. Further, if the controller 22 of each private branch exchange 2 and the controller 32 of each IP telephone 3 are expected to have a function to store various kinds of setting information, the memory 26 may be included in the controller 22 and the memory 33 may be included in the controller 32.

Further, as mentioned above, it is possible to perform the setting of the delay time hierarchically according to types of terminal equipments (refer to S30 and S40 of FIG. 6). Moreover, although the hierarchies of the setting of the delay time are distinguished by the private branch exchanges 2 and the IP telephones 3, the delay time may be set to more multi-level hierarchies according to the hierarchies or duties of users of the IP telephones 3. Similarly, with respect to the private branch exchanges 2 and the router 4, the delay time may be set to more multi-level hierarchies.

This application is based upon and claims the benefit of priorities of Japanese Patent Application Nos. 2005-83100 filed on Mar. 23, 2005; 2005-85507 filed on Mar. 24, 2005 and 2006-30811 filed on Feb. 8, 2005, the contents of which are incorporated herein by reference in its entirety.

### INDUSTRIAL APPLICABILITY

The present invention is suited to terminals unit and private branch exchanges which perform communicating setting over a LAN, a communication address notification method of the terminal equipments, and a communication address notification method of the private branch exchanges.

What is claimed is:

1. A private branch exchange comprising:
a communicator connected to a plurality of terminal units and a plurality of private branch exchanges;
a memory which stores identity information of the plurality of terminal units and communicating information of the plurality of the terminal units; and
a controller, when the controller has received identity information from one terminal unit of the plurality of terminal units, broadcast-transmits the communicating information to a plurality of terminal units including the one terminal unit and a plurality of private branch exchanges if the communicating information corresponding to the received identity information is in the memory.

2. The private branch exchange according to claim 1, wherein the identity information is MAC addresses for identifying the terminal units, and
wherein the communicating information is configured by correlating with one another the identity information, IP addresses, and the IP addresses of the private branch exchanges which accommodate the terminal units.

3. The private branch exchange according to claim 1, wherein the memory further stores a response delay time for which the controller waits a response to the plurality of terminal units, and
wherein, when the controller has received identity information from one terminal unit of the plurality of terminal units, the controller further delays transmission of the communicating information to the one terminal unit until the response delay time has elapsed if the communicating information corresponding to the received identity information is in the memory.

4. The private branch exchange according to claim 3, wherein, when the controller has received the communicating information of the one terminal unit from other private branch exchanges or other terminal units during the response delay time, the controller quits the transmission of the communicating information of the one terminal unit.

5. The private branch exchange according to claim 3, wherein, when the controller has received a communication address request notification that inquires about the communicating information, the controller broadcast-transmits a communication address response notification including the address of the private branch exchange if the communicating information of the terminal unit to be accommodated is included in the memory to be searched by the controller, and
wherein, when the controller has received a registration request notification which requests registration to the registration destination on the basis of the communication address response notification, the controller registers the terminal unit with the memory, and unicast-transmits a registration response notification including the communicating information.

6. The private branch exchange according to claim 5, wherein the communication address request notification includes the identity information of the terminal unit, the communication address response notification includes the communicating information of the private branch exchange to accommodate the terminal unit, the registration of the memory includes a registration indicating that the terminal unit is connected.

7. The private branch exchange according to claim 5, wherein, when the controller has received the communication address response notification from other private branch exchanges or other terminal units, the controller quits transmission of a communication address response notification that the private branch exchange itself will transmit.

8. The private branch exchange according to claim 5, wherein, when the controller has received the communication address request notification, the controller broadcast-transmit a communication address response notification including the address of the private branch exchange as an registration destination if the terminal unit to be accommodated is included in the communicating information of the memory to be searched by the controller, and the communicator has not received other communication address response notification.

9. The private branch exchange according to claim 8, wherein the private branch exchange further includes a timer which measures time,
wherein the communicating information includes a response delay time, and the measurement time of the timer is a time value calculated and determined by the controller on the basis of the response delay time and the address of the private branch exchange itself, and
wherein, when the controller has received the communication address request notification, the controller starts measurement of the timer and waits transmission of the communication address response notification, and when the communicator has received the communication address response notification during the measurement time, the controller controls to quit the transmission of the communication address response notification.

10. A private branch exchange system in which a plurality of terminal units are connected to one or a plurality of private branch exchanges over a network,
the private branch exchange including:
a communicator connected to a plurality of terminal units and a plurality of private branch exchanges;
a memory which stores identity information of the plurality of terminal units and communicating information of the plurality of terminal units; and
a controller which controls processing of the private branch exchange, and
the terminal unit including:
a terminal communicator connected to one or a plurality of terminal units and a plurality of private branch exchanges;
a terminal memory which stores terminal unit identity information of the terminal unit and terminal communicating information of the private branch exchange; and
a terminal unit controller which controls processing of the terminal unit;
wherein terminal unit identity information that inquires about the communicating information of the private branch exchange to be an registration destination is broadcast-transmitted from the terminal unit newly connected to the network
wherein, if the communicating information or the terminal communicating information corresponding to the terminal unit identity information is in the memory or the terminal memory, either the private branch exchange or the terminal unit which has received the terminal unit identity information, broadcast-transmits the communicating information or the terminal communicating information of the private branch exchange as the registration destination to the plurality of terminal units and the plurality of private branch exchanges.

11. The private branch exchange system according to claim 10, wherein the identity information is MAC addresses for identifying the terminal units,
wherein the communicating information is configured by correlating with one another the identity information, IP addresses, and the IP addresses of the private branch exchanges as registration destinations, and
wherein the terminal communicating information includes the IP addresses of the terminal units themselves and the IP addresses of the private branch exchanges as the registration destinations.

12. The private branch exchange system according to claim 10, wherein the memory further stores a response delay time for which the controller waits a response to the plurality of terminal units,
wherein the terminal memory further stores a terminal unit response delay time for which the terminal unit controller waits a response to the plurality of terminal units,
wherein each of the private branch exchange and the terminal unit which has received the terminal unit identity information delays broadcast transmission of the communicating information or the terminal communicating information of the private branch exchange as the registration destination to the plurality of terminal units and the plurality of private branch exchanges until the response delay time or the terminal unit response delay time has elapsed.

13. The private branch exchange system according to claim 12, wherein, when each of the private branch exchange and the terminal unit has received other communicating information or terminal communicating information during the response delay time or the terminal unit response delay time, it quits transmission of the communicating information or terminal communicating information.

14. The private branch exchange system according to claim 10, wherein terminal unit identity information notification that inquires about the communicating information of the private branch exchange to be an registration destination is broadcast-transmitted from the terminal unit newly connected to the network,
wherein, if the communicating information of the terminal unit to be accommodated is included in the memory or the terminal memory searched, either the private branch exchange or the terminal unit which has received the terminal unit identity information, broadcast-transmits a communication address response notification including the address of the private branch exchange as the registration destination, in the communicating information or the terminal communicating information, and
wherein the newly connected terminal unit unicast-transmits a registration request notification that requests a registration to the private branch exchange as the registration destination on the basis of the received communication address response notification.

15. The private branch exchange system according to claim 14, wherein the communication address request notification includes the terminal communicating information of the newly connected terminal unit, and the communication address response notification includes the communicating information of the private branch exchange which accommodates the terminal unit.

16. The private branch exchange system according to claim 14, wherein, when the communicator or the terminal communicator has received the communication address response notification from other private branch exchange or other terminal unit, the controller or the terminal unit controller controls to quit transmission of a communication address response notification that the private branch exchanger or the terminal unit itself will transmit.

17. The private branch exchange system according to claim 14, wherein, when the controller or the terminal unit controller has received the communication address request notification, the controller or the terminal unit controller broadcast-transmits a communication address response notification including the address of the private branch exchange as the registration destination, if the communicating information of the terminal unit to be accommodated is included in the communicating information or the terminal communicating information and the communicator or the terminal communicator has not received other communication address response notification.

18. The private branch exchange system according to claim 17, wherein the private branch exchange further includes a timer which measures time, and the terminal unit further includes a terminal timer which measures time,
wherein the communicating information includes a response delay time, and the terminal communicating information includes a terminal unit response delay time,
wherein the measurement time of the timer is a time value calculated and determined by the controller on the basis of the response delay time and the address of the private branch exchange itself,
wherein the measurement time of the terminal timer is a time value calculated and determined by the terminal unit controller on the basis of the terminal unit response delay time and the address of the terminal unit itself,
wherein, when the controller or the terminal unit controller has received the communication address request notification, the controller or the terminal unit controller starts measurement of the timer or the terminal timer and waits transmission of the communication address response notification, and
wherein, when the communicator or the terminal communicator has received the communication address response notification during the measurement time, the controller or the terminal unit controller controls to quit the transmission of the communication address response notification.

19. A terminal unit registration method of a private branch exchange system in which a plurality of terminal units are connected to one or a plurality of private branch exchanges over a network,
the private branch exchange including:
a communicator connected to a plurality of terminal units and a plurality of private branch exchanges;
a memory which stores identity information of the plurality of terminal units and communicating information of the plurality of terminal units; and
a controller which controls processing of the private branch exchange, and
the terminal unit including:
a terminal communicator connected to one or a plurality of terminal units and a plurality of private branch exchanges;
a terminal memory which stores terminal unit identity information of the terminal unit and terminal communicating information of the private branch exchange; and
a terminal unit controller which controls processing of the terminal unit;
the method comprising:
an address request step of broadcast-transmitting terminal unit identity information that inquires about the communicating information of the private branch exchange to be an registration destination is from the terminal unit newly connected to the network, and
an address response step in which, if the communicating information or the terminal communicating information corresponding to the terminal unit identity information is in the memory or the terminal memory, either the private branch exchange or the terminal unit which has received the terminal unit identity information broadcast-transmits the communicating information or the terminal communicating information of the private branch exchange as the registration destination to the plurality of terminal units and the plurality of private branch exchanges.

20. The terminal unit registration method of a private branch exchange system according to claim 19,
wherein the memory further stores a response delay time for which the controller waits a response to the plurality of terminal units,
wherein the terminal memory further stores a terminal unit response delay time for which the terminal unit controller waits a response to the plurality of terminal units,
the method further comprising
a response waiting step in which each of the private branch exchange and the terminal unit which has received the terminal unit identity information delays broadcast transmission of the communicating information or the terminal communicating information of the private branch exchange as the registration destination to the plurality of terminal units and the plurality of private branch exchanges until the response delay time or the terminal unit response delay time has elapsed.

21. The terminal unit registration method of a private branch exchange system according to claim 20, further comprising:
a response stopping step in which, when each of the private branch exchange and the terminal unit has received other communicating information or terminal communicating information in the response waiting step, it quits transmission of the communicating information or terminal communicating information.

22. The terminal unit registration method of a private branch exchange system according to claim 21, wherein each of the private branch exchange and the terminal unit starts the waiting step when it has received terminal unit identity information, and executes the address response step if the response stopping step was not performed during the waiting step.
